(19) United States
(12) Patent Application Publication
(10) Pub. No.: US 2025/0005895 A1
(43) Pub. Date: Jan. 2, 2025

(54) ADAPTIVE DEPTH COMPLETION

(71) Applicants: Denso International America, Inc., Southfield, MI (US); DENSO CORPORATION, Kariya (JP); Carnegie Mellon University, Pittsburgh, PA (US)

(72) Inventors: Shawn Hunt, Bethel Park, PA (US); Matthew O’Toole, Pittsburgh, PA (US); Kris Kitani, Pittsburgh, PA (US); Jinhyung Park, Pittsburgh, PA (US)

(21) Appl. No.: 18/493,517

(22) Filed: Oct. 24, 2023

Related U.S. Application Data
(60) Provisional application No. 63/523,939, filed on Jun. 29, 2023.

(51) Int. Cl. G06V 10/75; G06V 10/40; G06V 10/771; G06V 10/98

(52) U.S. Cl. CPC G06V 10/7515; G06V 10/513; G06V 10/758; G06V 10/771; G06V 10/993

(57) ABSTRACT

Systems, methods, and other embodiments described herein relate to a deep learning approach for depth completion according to variable depth inputs. In one embodiment, a method includes acquiring sensor data including at least an image of a surrounding environment. The method includes encoding the sensor data into features using an encoder of a depth model. The method includes decoding the features into a depth map using a decoder of the depth model according to an affinity-based shift correction embedded with the decoder. The method includes providing the depth map that indicates depths within the surrounding environment.

### CROSS-REFERENCE TO RELATED APPLICATION

This application claims the benefit of U.S. Provisional Patent Application No. 63/523,939, filed Jun. 29, 2023, which is incorporated by reference herein in its entirety.

### TECHNICAL FIELD

The subject matter described herein relates in general to systems and methods for improving depth data and, more particularly, to using a machine learning model to perform depth completion according to variable depth inputs.

### BACKGROUND

Various devices that provide information about a surrounding environment often use sensors that facilitate perceiving obstacles and additional aspects of the surrounding environment. As one example, a device uses information from the sensors to develop awareness of the surrounding environment in order to identify and avoid hazards when navigating the environment. In particular, the device uses the perceived information to determine a 3-D structure of the environment so that the device may distinguish between navigable regions and potential hazards. The ability to perceive distances using sensor data provides the device (e.g., an autonomous vehicle) with the ability to plan movements through the environment and generally improve situational awareness about the environment.

In one approach, the device may employ cameras to perceive the surrounding environment. While this approach can avoid the use of more expensive sensors (e.g., LiDAR), the captured images do not explicitly include depth information. Instead, the device can implement processing routines that derive depth information from the monocular images. Using monocular images alone to derive depth information can encounter difficulties, such as depth inaccuracies and various types of aberrations. Similarly, using LiDAR data alone to provide depth information also presents difficulties, such as high computational loads from the amount of data, issues with depth completion when the data is sparse, added costs, etc. Consequently, difficulties persist with accurately perceiving depth information about a surrounding environment.

### SUMMARY

In one embodiment, example systems and methods associated with improving depth data through the use of a machine learning model that integrates available depth data are disclosed. As previously noted, the determination of depth within an environment can present various difficulties. As one approach, a system can implement an explicit depth sensor, such as a LiDAR. However, such sensors generally still do not provide complete depth information for the surrounding environment and can also represent a significant cost. That is, LiDAR sensors generate depth data in scan lines and at points along the lines. A resulting point cloud of depth data leaves a significant amount of space that is not sensed even with higher fidelity sensors. Alternative approaches involve the use of a monocular camera to capture monocular images that do not include explicit depth data, but instead rely on a trained neural network to infer depth data from the images. While this depth data is dense and generally complete in that depth values correspond with each pixel, the depth data can suffer from issues, such as scale ambiguity.

Therefore, in one embodiment, a disclosed approach involves using a monocular depth estimation model that processes monocular images to derive depth data but that also integrates explicit depth data when available. For example, in one approach, an inventive system implements a novel depth model having an encoder-decoder architecture. In general, the encoder is a convolutional neural network or similar network for encoding features of monocular images. The encoder may accept an image as the input or an image fused with depth data. In either case, the encoder generates a feature map that is an encoded abstraction of the original input. The encoder feeds the feature map to the decoder. The decoder is comprised of, for example, deconvolutional layers. In addition to the deconvolutional layers, in at least one arrangement, the system includes modules connected with each layer of the decoder. The modules function to integrate the explicit depth data into determinations of the resulting depth map at the separate layers.

For example, the modules perform affinity-based shift corrections using the depth data. The affinity-based shift correction operates to iteratively align depth predictions to the provided depth data according to predicted affinities between image pixels and depth points of the depth data. In general, the affinity-based shift correction uses depth errors of semantically similar regions to align the depth predictions with the input depth data. Subsequently, the system can also process the derived determinations of depth using a correction confidence module. The correction confidence module provides for selectively using the depth values associated with areas in the image according to a reliability of the correlation. In this way, the system provides an optimized depth map that integrates the explicit depth data with predictions from the monocular image, thereby improving the accuracy of the depth map.

In one embodiment, a depth system is disclosed. The depth system includes one or more processors and a memory that is communicably coupled to the one or more processors. The memory stores instructions that, when executed by the one or more processors, cause the one or more processors to acquire sensor data including at least an image of a surrounding environment. The instructions include instructions to encode the sensor data into features using an encoder of a depth model. The instructions include instructions to decode the features into a depth map using a decoder of the depth model according to an affinity-based shift correction embedded with the decoder. The instructions include instructions to provide the depth map that indicates depths within the surrounding environment.

In one embodiment, a non-transitory computer-readable medium is disclosed. The computer-readable medium stores instructions that, when executed by one or more processors, cause the one or more processors to perform the disclosed functions. The instructions include instructions to acquire sensor data including at least an image of a surrounding environment. The instructions include instructions to encode the sensor data into features using an encoder of a depth model. The instructions include instructions to decode the features into a depth map using a decoder of the depth model according to an affinity-based shift correction embedded with the decoder. The instructions include instructions to provide the depth map that indicates depths within the surrounding environment.

In one embodiment, a method is disclosed. The method includes acquiring sensor data including at least an image of a surrounding environment. The method includes encoding the sensor data into features using an encoder of a depth model. The method includes decoding the features into a depth map using a decoder of the depth model according to an affinity-based shift correction embedded with the decoder. The method includes providing the depth map that indicates depths within the surrounding environment.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle in which example systems and methods disclosed herein may operate.

FIG. 2 illustrates one embodiment of a depth system that is associated with improving the determination of depth data using a machine learning approach and variable depth inputs.

FIGS. 3A-C illustrate examples of point clouds depicting depth information for a scene.

FIG. 4 illustrates a diagram depicting one embodiment of a depth model.

FIG. 5 is a diagram illustrating one configuration of the depth model of FIG. 4.

FIG. 6 is a flowchart showing a method associated with using a depth model and variable depth inputs to derive depth maps.

### DETAILED DESCRIPTION

Systems, methods, and other embodiments associated with improving depth data through the use of a machine learning model that integrates available sparse depth data are disclosed herein. As previously noted, the determination of depth within an environment can present various difficulties. That is, hardware solutions, such as LiDAR, can encounter difficulties with incomplete information and costs. On the other hand, software-based solutions, such as monocular depth estimation, can encounter difficulties with accuracy, scale ambiguity, and so on. Accordingly, various approaches to determining depth information about an environment persist with the different solutions.

Therefore, in one embodiment, a depth system uses a monocular depth estimation model that processes monocular images to derive depth data but that also integrates explicit depth data when available. For example, in one approach, the depth system implements a novel depth model having an encoder-decoder architecture. In general, the encoder is a convolutional neural network or similar network for encoding features of monocular images. The encoder may accept an image as the input or an image fused with depth data. The depth data is, for example, explicit depth information from a sensor, such as a LiDAR, ultrasonic sensor, radar, stereo camera, etc. In general, the depth data is sparse, meaning that the depth data is not complete or comprehensive for the surrounding environment but instead is scattered across various aspects of the surrounding environment. In any case, the encoder generates a feature map that is an encoded abstraction of the original input. The encoder feeds the feature map to the decoder. The decoder is comprised of, for example, deconvolutional layers. In addition to the deconvolutional layers, in at least one arrangement, the system includes modules connected with each layer of the decoder. The modules function to integrate the explicit depth data into determinations of the resulting depth map at the separate layers.

For example, the modules perform affinity-based shift corrections using the depth data (i.e., data from a LiDAR or other depth sensor). The affinity-based shift correction operates to iteratively align depth predictions to the provided depth data according to predicted affinities between image pixels and depth points of the depth data. In general, the affinity-based shift correction uses depth errors of semantically similar regions to align the depth predictions with the input depth data. Subsequently, the system can also process the derived determinations of depth using a correction confidence module. The correction confidence module provides for selectively using the prior predictions according to a reliability of the predictions. In this way, the system provides an optimized depth map that integrates the explicit depth data with predictions from the monocular image, thereby improving the accuracy of the depth map.

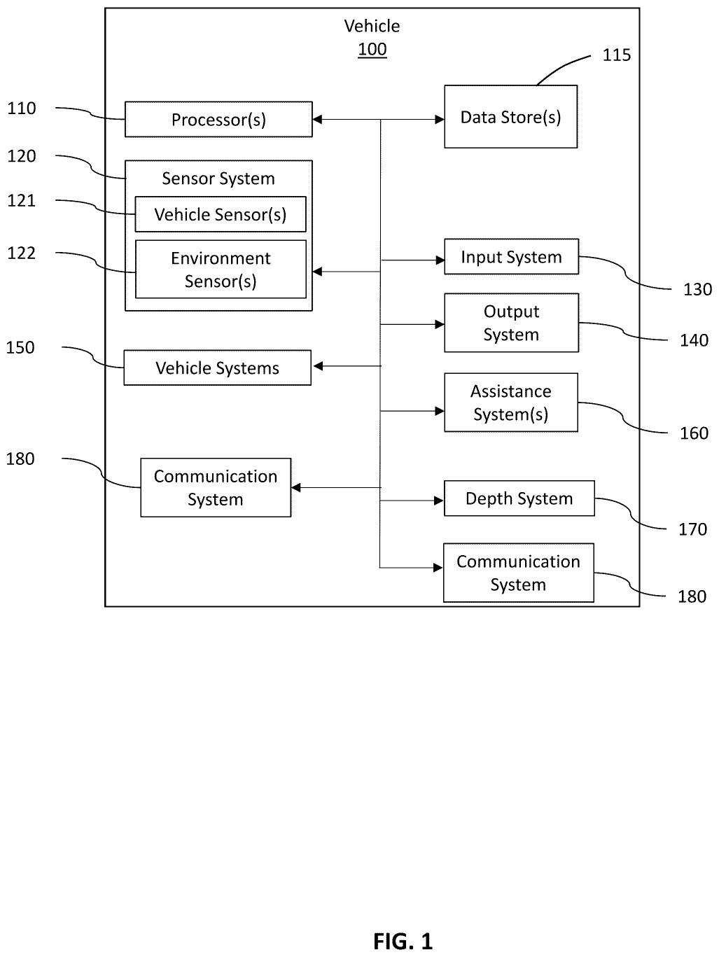

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any form of transport that benefits from the functionality discussed herein. In still further aspects, instead of a vehicle, the disclosed systems and methods may be implemented in a device that performs machine perception, such as a roadside unit (RSU), an aerial device (e.g., a drone), a mobile phone, and so on. Accordingly, the vehicle 100 is shown and described as including the depth system 170 for purposes of the present discussion; however, in further aspects, the depth system 170 may be implemented within other devices.

The vehicle 100 also includes various elements. It will be understood that, in various embodiments, the vehicle 100 may not have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

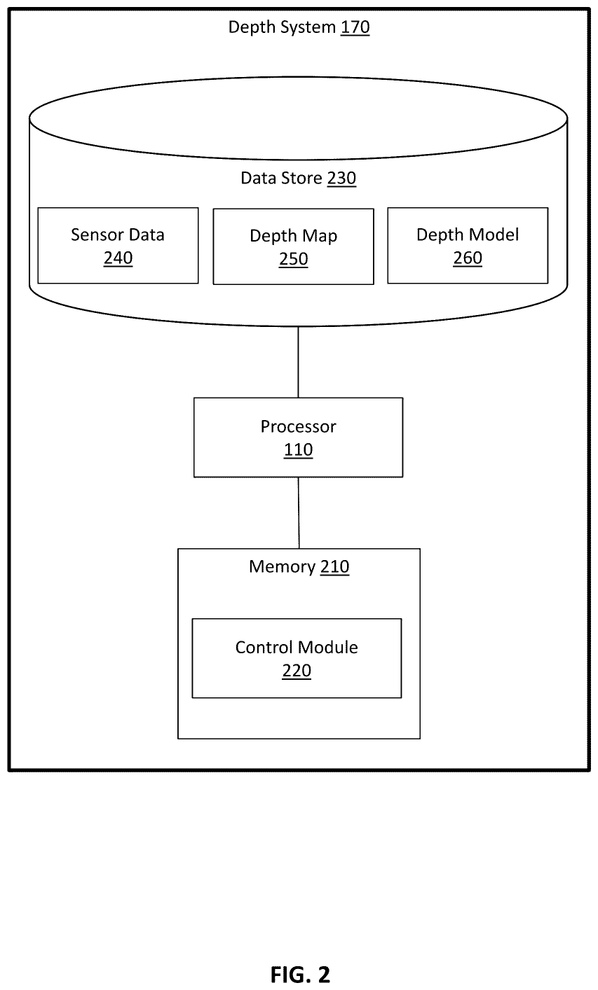

Some of the possible elements of the vehicle 100 are shown in FIG. 1 and will be described along with subsequent figures. A description of many of the elements in FIG. 1 will be provided after the discussion of FIGS. 2-6 for purposes of the brevity of this description. Additionally, it will be appreciated that for simplicity and clarity of illustration, where appropriate, reference numerals have been repeated among the different figures to indicate corresponding, analogous, or similar elements. Furthermore, it should be understood that the embodiments described herein may be practiced using various combinations of the described elements.

In any case, the vehicle 100 includes a depth system 170 that functions to improve the derivation of depth maps by using a machine learning model to process images and depth data together. Moreover, while depicted as a standalone component, in one or more embodiments, the depth system 170 is integrated with the assistance system 160 or another similar system of the vehicle 100 to facilitate functions of the other systems/modules. The noted functions and methods will become more apparent with a further discussion of the figures.

Furthermore, the assistance system 160 may take many different forms but generally provides some form of automated assistance to an operator of the vehicle 100. For example, the assistance system 160 may include various advanced driving assistance system (ADAS) functions, such as a lane-keeping function, adaptive cruise control, collision avoidance, emergency braking, and so on. In further aspects, the assistance system 160 may be a semi-autonomous or fully autonomous system that can partially or fully control the vehicle 100. Accordingly, the assistance system 160, in whichever form, functions in cooperation with sensors of the sensor system 120 to acquire observations about the surrounding environment from which additional determinations can be derived in order to provide the various functions.

As a further aspect, the vehicle 100 also includes a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via short-range communications, such as a Bluetooth, WiFi, or another suitable protocol for communicating between the vehicle 100 and other nearby devices (e.g., other vehicles). Moreover, the communication system 180, in one arrangement, further communicates according to a long-range protocol, such as the global system for mobile communication (GSM), Enhanced Data Rates for GSM Evolution (EDGE), or another communication technology that provides for the vehicle 100 communicating with a cloud-based resource. In either case, the system 170 can leverage various wireless communications technologies to facilitate communications with nearby vehicles (e.g., vehicle-to-vehicle (V2V)), nearby infrastructure elements (e.g., vehicle-to-infrastructure (V2I)), and so on. For example, in one or more arrangements, the depth system 170 may communicate acquired information (e.g., high-resolution radar-based maps) to nearby or remote entities.

With reference to FIG. 2, one embodiment of the depth system 170 is further illustrated. As shown, the depth system 170 includes a processor 110. Accordingly, the processor 110 may be a part of the depth system 170, or the depth system 170 may access the processor 110 through a data bus or another communication pathway. In one or more embodiments, the processor 110 is an application-specific integrated circuit that is configured to implement functions associated with a control module 220. More generally, in one or more aspects, the processor 110 is an electronic processor, such as a microprocessor, that is capable of performing various functions as described herein when executing encoded functions associated with the depth system 170.

In one embodiment, the depth system 170 includes a memory 210 that stores the control module 220. The memory 210 is a random-access memory (RAM), read-only memory (ROM), a hard disk drive, a flash memory, or other suitable memory for storing the module 220. The module 220 is, for example, computer-readable instructions that, when executed by the processor 110, cause the processor 110 to perform the various functions disclosed herein. While, in one or more embodiments, the module 220 is instructions embodied in the memory 210, in further aspects, the module 220 includes hardware such as processing components (e.g., controllers), circuits, etc. for independently performing one or more of the noted functions.

Furthermore, in one embodiment, the depth system 170 includes a data store 230. The data store 230 is, in one arrangement, an electronically-based data structure for storing information. For example, in one approach, the data store 230 is a database that is stored in the memory 210 or another suitable medium, and that is configured with routines that can be executed by the processor 110 for analyzing stored data, providing stored data, organizing stored data, and so on. In any case, in one embodiment, the data store 230 stores data used by the module 220 in executing various functions. In one embodiment, the data store 230 includes sensor data 240, depth map(s) 250, and a depth model 260 along with, for example, other information that is used by the control module 220.

Accordingly, the control module 220 generally includes instructions that function to control the processor 110 to acquire data inputs from one or more sensors of the vehicle 100 that form the sensor data 240. In general, the sensor data 240 includes information that embodies observations of the surrounding environment of the vehicle 100 or other device in which the depth system 170 is situated. The observations of the surrounding environment, in various embodiments, can include surrounding lanes, vehicles, objects, obstacles, etc. that may be present in the lanes, proximate to a roadway, within a parking lot, garage structure, driveway, or another area within which the vehicle 100 is traveling or parked.

While the control module 220 is discussed as controlling the various sensors to provide the sensor data 240, in one or more embodiments, the control module 220 can employ other techniques to acquire the sensor data 240 that are either active or passive. For example, the control module 220 may passively sniff the sensor data 240 from a stream of electronic information provided by the various sensors to further components within the vehicle 100. Moreover, the control module 220 can undertake various approaches to fuse data from multiple sensors when providing the sensor data 240. Thus, the sensor data 240, in one embodiment, represents a combination of perceptions acquired from multiple sensors and/or other aspects of the vehicle 100. For example, in a further configuration, the sensor data 240 may include information acquired via the communication system 180, such as data from other vehicles and/or infrastructure devices. That is, the depth system 170 may acquire images and/or depth data from other vehicles, mobile devices, road-side units, etc.

In any case, the control module 220 acquires the sensor data 240 that includes at least monocular images from the camera 126 or another imaging device, such as a LiDAR via ambient environment lighting and intensity returns. That is, the camera 126 may generate RGB images using, for example, a charge-coupled device (CCD) type sensor and/or the LiDAR may generate an image according to intensity returns and ambient environment lighting that is distinct from point clouds typically generated using a LiDAR, which the LiDAR may still also generate in combination. The monocular images are generally derived from one or more monocular videos that are comprised of a plurality of frames. As described herein, the monocular images are, for example, images from the camera 126 or another imaging device that encompasses a field-of-view (FOV) about the vehicle 100 of at least a portion of the surrounding environment. That is, a monocular image is, in one approach, generally limited to a subregion of the surrounding environment. As such, the image may be of a forward-facing (i.e., the direction of travel) 60, 90, 120-degree FOV, a rear/side facing FOV, or some other subregion as defined by the imaging characteristics (e.g., lens distortion, FOV, etc.) of the camera 126. In various aspects, the camera 126 is a pinhole camera, a fisheye camera, a catadioptric camera, or another form of camera that acquires images without a specific depth modality.

An individual monocular image itself includes visual data of the FOV that is encoded according to an imaging standard (e.g., codec) associated with the camera 126 or another imaging device that is the source. In general, characteristics of a source camera (e.g., camera 126) and the video standard define a format of the monocular image. Thus, while the particular characteristics can vary according to different implementations, in general, the image has a defined resolution (i.e., height and width in pixels) and format. Thus, for example, the monocular image is generally an RGB visible light image. In further aspects, the monocular image can be an infrared image associated with a corresponding infrared camera, a black/white image, or another suitable format as may be desired. Whichever format that the depth system 170 implements, the image is a monocular image in that there is no explicit additional modality indicating depth nor any explicit corresponding image from another camera from which the depth can be derived (i.e., no stereo camera pair). In contrast to a stereo image that may integrate left and right images from separate cameras mounted side-by-side to provide an additional depth channel, the monocular image does not include explicit depth information, such as disparity maps derived from comparing the stereo images pixel-by-pixel. Instead, the depth system 170 employs the depth model 260 to derive depth information from implicit relationships of perspective and size of elements depicted within the image.

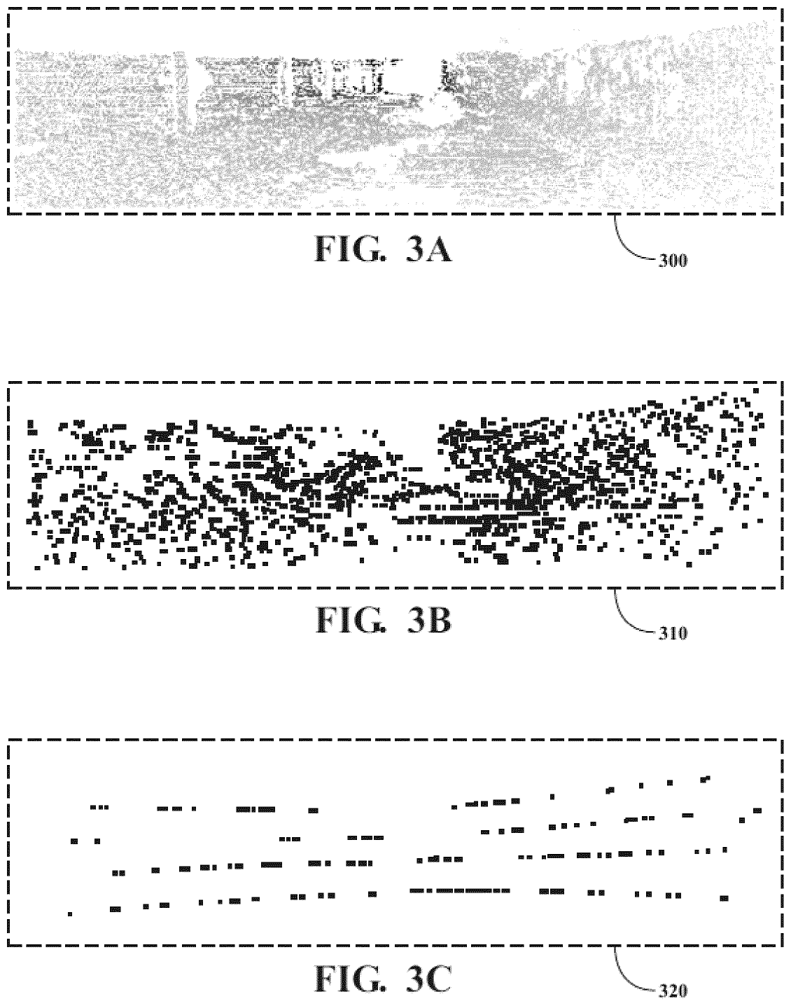

Additionally, the sensor data 240, in one or more arrangements, further includes depth data about a scene depicted by the associated monocular images. The depth data indicates distances from a range sensor that acquired the depth data to features in the surrounding environment. The depth data, in one or more approaches, is sparse or generally incomplete for a corresponding scene such that the depth data includes sparsely distributed points within a scene that are annotated by the depth data as opposed to a depth map (e.g., depth map 250) that generally provides comprehensive depths for each separate depicted pixel. Consider FIGS. 3A, 3B, and 3C, which depict separate examples of depth data for a common scene. FIG. 3A depicts a depth map 300 that includes a plurality of annotated points generally corresponding to an associated monocular image on a per-pixel basis. Thus, the depth map 300 includes about 18,288 separate annotated points.

By comparison, FIG. 3B is an exemplary 3D point cloud 310 that may be generated by a LiDAR device having 64 scanning beams. Thus, the point cloud 310 includes about 1,427 separate points. Even though the point cloud 310 includes substantially fewer points than the depth map 300, the depth data of FIG. 3B represents a significant cost to acquire over a monocular image. These costs and other difficulties generally relate to an expense of a robust LiDAR sensor that includes 64 separate beams, difficulties in calibrating this type of LiDAR device with the monocular camera, storing large quantities of data associated with the point cloud 310 for each separate image, and so on. As an example of sparse depth data, FIG. 3C depicts a point cloud 320. In the example of the point cloud 320, a LiDAR having 4 beams generates about 77 points that form the point cloud 320. Thus, in comparison to the point cloud 310, the point cloud 320 includes about 5% of the depth data as the point cloud 310, which is a substantial reduction in data. However, the sparse information depicted by point cloud 320 is generally insufficient to develop a comprehensive assessment of the surrounding environment.

As an additional comparison of the FIGS. 3A-3C, note that within FIGS. 3A and 3B, the depth data is sufficiently dense to convey details of existing features/objects such as vehicles, etc. However, within the point cloud 320 of FIG. 3C, the depth data is sparse or, stated otherwise, the depth data vaguely characterizes the corresponding scene according to distributed points across the scene that do not generally provide detail of specific features/objects depicted therein. Thus, this sparse depth data that is dispersed in a minimal manner across the scene may not provide enough data for some purposes. While the depth data is generally described as originating from a LiDAR, in further embodiments, the depth data may originate from a stereo camera, radar, or another range sensor. Furthermore, the depth data itself generally includes depth/distance information relative to a point of origin, such as the range sensor that may be further calibrated in relation to the camera 126, and may also include coordinates (e.g., x, y within an image) corresponding with separate depth measurements.

Continuing with the description of elements stored by the depth system 170, the depth map 250 is a mapping of depths within the surrounding environment corresponding to the original input image. That is, in at least one approach, the depth 250 provides depth values corresponding to pixels in the original image. As such, the depth map 250 provides dense depth information for a depicted scene where the depth values are relative to a position of the camera within the environment.

The depth model 260 is, in one or more arrangements, a convolutional neural network (CNN) with an encoder-decoder architecture that can be broadly characterized as, in at least one configuration, a monocular depth estimation model. Additionally, to integrate the explicit depth data, the depth model 260 includes affinity-based shift correction modules associated with separate stages of the decoder. The modules function to inject the depth data into the decoder such that the provided depth map 250 considers both the image and the depth data.

Accordingly, with further reference to FIG. 2, the control module 220 includes instructions that, when executed by the processor 110, cause the processor to apply the depth model 260 to the sensor data 240 and generate the depth map 250. As further explanation, consider the following.

The control module 220 implements the depth model 260 with the affinity-based shift correction module to adaptively propagate depth information (e.g., sparse depth data) from each input point across an entire corresponding image. For example, a single decoder stage of the depth model 260, let [symbol] denote the image feature map of shape H′×W′×C and let [symbol] ={(pⱼ, dⱼ)}ⱼ₌₁^{N} denote the list of N input depth points, where pⱼ and dⱼ are the 2D projection and the depth of the j-th depth point, respectively. The control module 220 first applies the depth model 260 to predict an initial depth map D^{initial}∈ [symbol] ^{H′×W′×1} from [symbol] using a multi-layer perceptron (MLP). At a high level, the affinity-based shift correction module aligns the initial depth map prediction to points of the input depth data and fuse the data back into [symbol] for a next decoder stage of the depth model 260.

In regards to the affinity computation itself, the control module 220 uses the depth data as a reference about which depth predictions align. The control module 220 uses the depth model 260 to identify regions in the image for which each depth point of the depth data should act as a reference point. The control module 220, in one approach, computes the affinity between each pair of image pixels and the points of the depth data, where the affinity represents the extent to which each depth point should contribute to the alignment of each image pixel. In general, the range of influence of each depth point depends on the distribution of and number of input points. As one example, between 64-line and 4-line LiDAR, the distance between each image pixel to its nearest depth point varies from 5 to 30 points. Thus, the control module 220 generates features for each depth point by, in one approach, adding 2D positional embeddings to the image features, denoted [symbol] , sampling image features at each depth point projection, and leveraging a single transformer layer according to equation (1).

$${\{ {f}_{j}^{P} \}}_{j = 1}^{N} = TransformerEncoder ( {\{ [ {ℱ}^{′} [ {p}_{j} ] , {d}_{j} ] \}}_{j = 1}^{N} ) \qquad ( 1 )$$

where [ [symbol] [pⱼ] indicates bilinearly sampling [symbol] at position pⱼ and [.,.] denotes a concatenation. Employing the cross-attention mechanism, the control module 220 determines the affinity between feature map pixel fᵢ^{l} and input depth point (pⱼ, dⱼ) according to equation (2).

$${𝒜}_{i j} = {Softmax}_{j} ( {( {W}_{q} {f}_{i}^{I} )}^{T} ( {W}_{k} {f}_{j}^{P} ) ) \qquad ( 2 )$$

where softmax is over the depth data.

Using the affinities, the control module 220 creates a shift-corrected depth map D^{shift}, which corrects each pixel in D^{initial} using depth errors of semantically similar pixels. The control module 220 finds the shift-corrected depth of pixel i according to equation (3).

$${D}_{i}^{shift} = {D}_{i}^{initial} + {\sum }_{j = 1}^{N} {𝒜}_{i j} ( {d}_{j} - {D}_{j}^{initial} ) \qquad ( 3 )$$

The summation is the weighted average of depth errors in the initial depth map prediction for pixels j that have input depth data points, where the weights are each pixel j's affinity, or semantic/location similarity, to pixel i. Accordingly, if pixel i is on an object (e.g., a vehicle) and the object is predicted to be close, then the depth prediction for pixel i will be shifted accordingly. By supervising D^{shift}, the control module 220 can adaptively influence regions for which a depth point can serve as an effective reference for alignment. In addition to shift correction, the control module 220 also uses affinities to take a weighted sum over the point features to get a feature map [symbol] ^{point}. The control module 220 fuses the point feature weighted sum and the shift corrected depth map with the initial decoder features and uses the fused result as input to the next decoder stage of the depth model 260. Moreover, in one aspect, as an alternative for the first decoder stage, the control module 220 fuses the weighted sum of depth point features for the first decoder stage. This alternative for the first decoder stage alone can improve results and generates scale-consistent predictions for subsequent decoder stages.

The control module 220 further implements, in at least one configuration, a correction confidence prediction along with the affinity-based shift correction. Because shift-corrected predictions may, in certain circumstances, introduce additional error, the control module 220 implements the correction confidence prediction to select which of the predictions to apply in the fused depth map at each stage of the decoder. For example, in at least one approach, the control module 220 combines the initial and corrected depth predictions and fuses only select predictions for each depth map. The control module 220 fuses the depth into the decoder feature according to equations (4) and (5).

$${D}^{fuse} = ( 1 - {𝓌}_{f u s e} ) ∘ {D}^{initial} + {𝓌}_{f u s e} ∘ {D}^{shift} \qquad ( 4 )$$

$${𝓌}_{f u s e} = σ ( {ϕ}_{θ} ( [ {ℱ}^{′} , {ℱ}^{point} , {D}^{initial} , {D}^{shift} , {ℱ}^{dist} ] ) ) \qquad ( 5 )$$

where [symbol] ^{dist} is the normalized distance of each pixel to its nearest depth point, ϕ_{θ} is a lightweight CNN head, σ is the sigmoid function, and [symbol] _{fuse} is a 1-channel confidence map. In this way, the control module 220 implements the depth model 260 to improve performance for sparse depth data.

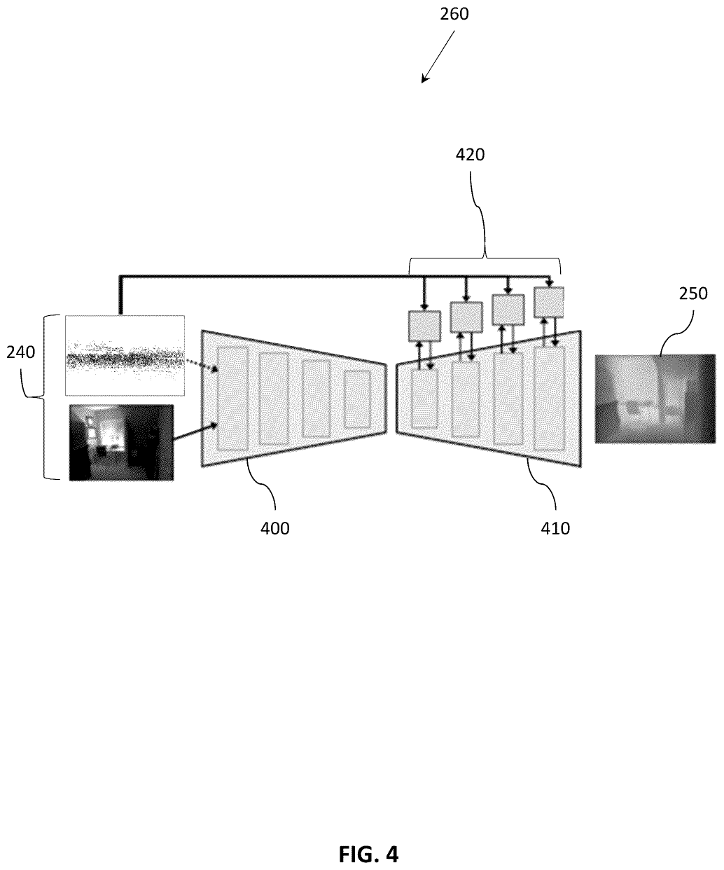

With reference to FIG. 4, one configuration of the depth model 260 is shown. As illustrated, the sensor data 240 is the input to an encoder 400 of the depth model 260. It should be noted that while the sensor data 240 is shown as being input to the encoder 400, the depth data may skip the encoder 400 and be provided directly to the decoder 410 via affinity-based shift correction modules 420. That is, the depth model 260 may be arranged to accept the monocular image and the depth data fused into a single input where the depth data is added as an additional channel of the RGB monocular image such that the monocular image is then an RGB-D image with the fused sparse depth data. However, in further embodiments, the depth data is instead not fused with the monocular image and is instead injected into the decoder 410 via the affinity-based shift correction modules 420 at the separate stages of the decoder 410. In any case, the depth model 260, as illustrated, has an encoder-decoder architecture with additional connections in the decoder 410 for the affinity-based shift correction modules 420.

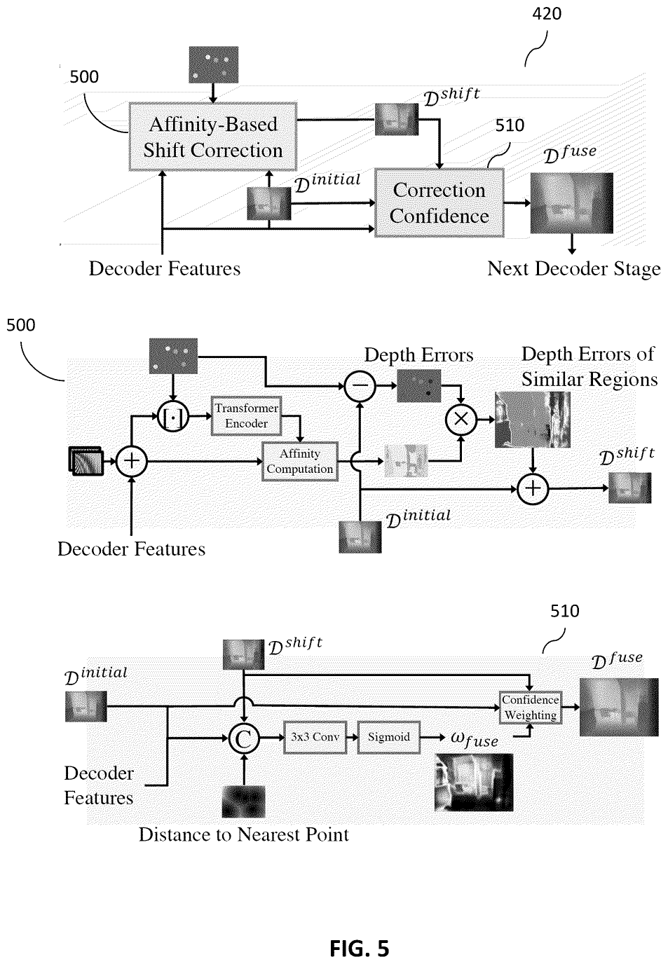

FIG. 5 illustrates further details of the depth model 260 with particular specificity to the affinity-based shift correction modules 420. FIG. 5 shows an example of one of the affinity-based shift correction modules 420, which are all generally configured in the same arrangement. Thus, FIG. 5 shows the module 420 with an affinity-based shift correction component that receives decoder features from a respective stage of the decoder 410 along with an initial depth map (i.e., a depth map from the decoder stage without any modification according to the correction) and depth data. The affinity-based shift correction component incorporates the depth data and generates a shifted depth map according to the affinity-based correction. This information along with the initial depth map are provided into a correction confidence component 510 that selects which predictions to fuse into the fused depth map that is provided as output to the next decoder stage.

With continued reference to FIG. 5, the affinity-based shift correction component 500 is shown in yet further detail. The affinity-based shift correction component 500 is illustrated with additional functions as explained above where the component 500 derives the depth errors to identify semantically similar/dissimilar regions in order to correlate the depth data with the initial depth map from which the affinity-based shift correction component determines how to generate the shifted depth map according to the respective affinities.

Thus, the shifted depth map is then fed to the correction confidence component 510, as shown in further detail in FIG. 5. The correction confidence component 510 derives confidence weighting values to determine which of the values from the shifted depth map to fuse and generate the output fused depth map with the final predictions for the respective decoder stage. In this way, the depth system 170 uses the depth model 260 to integrate explicit depth information with inferred depth points from the monocular image and improve the determination of the depth map 250.

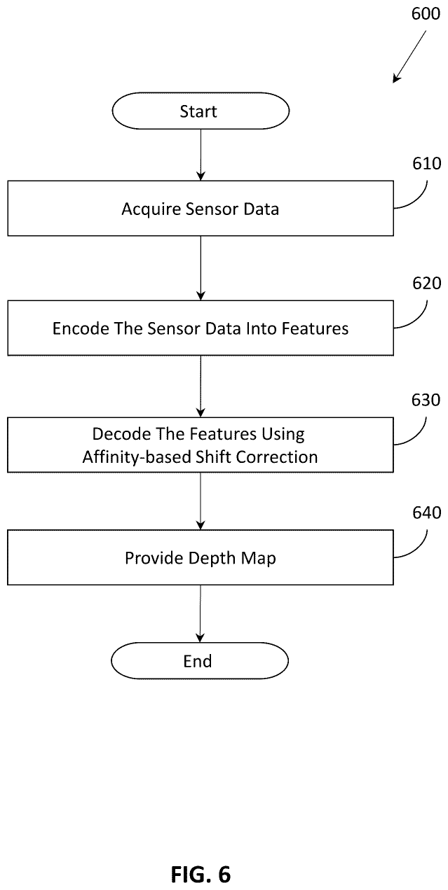

Additional aspects of improving the derivation of depth maps through the use of affinity-based shift correction to integrate explicit depth data with predicted information will be discussed in relation to FIG. 6. FIG. 6 illustrates a method 600 associated with processing a monocular image and available depth data (e.g., sparse depth data) into a depth map using a depth model configured with affinity-based shift correction. Method 600 will be discussed from the perspective of the depth system 170 of FIG. 1. While method 600 is discussed in combination with the depth system 170, it should be appreciated that the method 600 is not limited to being implemented within the depth system 170 but is instead one example of a system that may implement the method 600.

At 610, the control module 220 acquires the sensor data 240. In one embodiment, acquiring the sensor data 240 includes controlling one or more sensors of the vehicle 100 to generate observations about the surrounding environment of the vehicle 100. The control module 220, in one or more implementations, iteratively acquires the sensor data 240 from one or more sensors of the sensor system 120. The sensor data 240 includes observations of a surrounding environment of the vehicle 100. As noted previously, the sensor data 240 includes at least a monocular image and may further include depth data from a LiDAR or another depth sensor. Moreover, the depth data itself is generally sparse depth data, as noted previously. Furthermore, while the present disclosure generally describes the depth data as being integrated into the decoder stage directly, in various arrangements, the depth data is instead initially fused with the monocular image.

In any case, the depth system 170 generally acquires both forms of data as input. It should be noted that while the depth system 170 is primarily described as utilizing both depth data and image data, the depth system 170 can still generate the depth map 250 without the input of explicit depth data. That is, when depth data is available, the depth system 170 integrates the depth data via the affinity-based shift correction module. Otherwise, when such data is not available, the depth system 170 deactivates the modules. The present description of method 600 focuses on the instance when the depth data is available.

At 620, the control module 220 encodes the sensor data 240 into features using an encoder of a depth model 260. Encoding the sensor data 240 generally involves iteratively refining abstract representations of the input image via a series of encoder stages. For example, in the instance where the encoder is a convolutional-based encoder, the control module 220 convolves a filter over the image to generate a representation of the image. As a result, the control module 220 generates a feature map at each stage of the encoder that is fed to a subsequent stage for further processing and ultimately to the decoder.

At 630, the control module 220 decodes the features into a depth map using a decoder of the depth model 260 according to an affinity-based shift correction embedded with the decoder. As previously outlined, the depth model 260 uses the affinity-based shift correction module to integrate the sparse depth data into the decoder. Moreover, the affinity-based shift correction functions to iteratively align depth predictions (e.g., initial depth map predictions otherwise referred to as an intermediate depth map) to sparse depth data. Broadly stated, the control module 220 is using the affinity-based shift correction module to compute an affinity between pairs of the depth points and pixels of the intermediate depth map, which further involves determining depth errors to correct the depth map. For example, the control module 220 also applies a correction confidence prediction to selectively integrate information from sparse depth data into decoding the depth map in order to avoid correlations that may negatively influence the depth map because of particular geometries in the image.

At 640, the control module 220 provides the depth map 250 that indicates depths within the surrounding environment. In various implementations, the control module 220 provides the depth map 250 by, for example, communicating the depth map 250 to one or more systems within the vehicle 100 to facilitate control of the vehicle 100. That is, the depth system 170 may be integrated with an assistance system 160 that controls the vehicle 100 to perform various actions according to information perceived within the depth map 250. In one implementation, the assistance system 160 provides advanced driving assistance to, for example, prevent collisions. Thus, the depth system 170 may provide the depth map 250 to facilitate identification of obstacles and associated positions of the obstacles within the environment, thereby improving operation of the assistance system 160 and control of the vehicle 100. Of course, while driving assistance is provided as one example, the depth system 170 may be implemented to improve other functions as well, such as semi-autonomous driving, autonomous driving, and so on.

Additionally, it should be appreciated that the depth system 170 from FIG. 1 can be configured in various arrangements with separate integrated circuits and/or electronic chips. In such embodiments, the control module 220 is embodied as a separate integrated circuit. The circuits are connected via connection paths to provide for communicating signals between the separate circuits. Of course, while separate integrated circuits are discussed, in various embodiments, the circuits may be integrated into a common integrated circuit and/or integrated circuit board. Additionally, the integrated circuits may be combined into fewer integrated circuits or divided into more integrated circuits. In further embodiments, portions of the functionality associated with the module 220 may be embodied as firmware executable by a processor and stored in a non-transitory memory. In still further embodiments, the module 220 is integrated as hardware components of the processor 110.

In another embodiment, the described methods and/or their equivalents may be implemented with computer-executable instructions. Thus, in one embodiment, a non-transitory computer-readable medium is configured with stored computer-executable instructions that, when executed by a machine (e.g., processor, computer, and so on), cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner. “Manual mode” means that all of or a majority of the navigation and/or maneuvering of the vehicle is performed according to inputs received from a user (e.g., human driver).

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is fully automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the depth system 170 to ensure the vehicle 100 remains within defined state constraints.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 (e.g., data store 230) for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data. The map data can include maps of one or more geographic areas. In some instances, the map data can include information (e.g., metadata, labels, etc.) on roads, traffic control devices, road markings, structures, features, and/or landmarks in the one or more geographic areas. In some instances, the map data can include aerial/satellite views. In some instances, the map data can include ground views of an area, including 360-degree ground views. The map data can include measurements, dimensions, distances, and/or information for one or more items included in the map data and/or relative to other items included in the map data. The map data can include a digital map with information about road geometry. The map data can further include feature-based map data such as information about relative locations of buildings, curbs, poles, etc. In one or more arrangements, the map data can include one or more terrain maps. In one or more arrangements, the map data can include one or more static obstacle maps. The static obstacle map(s) can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level.

The one or more data stores 115 can include sensor data (e.g., sensor data 240). In this context, “sensor data” means any information from the sensors that the vehicle 100 is equipped with, including the capabilities and other information about such sensors.

As noted above, the vehicle 100 can include the sensor system 120. The sensor system 120 can include one or more sensors. “Sensor” means any device, component, and/or system that can detect, perceive, and/or sense something. The one or more sensors can be configured to operate in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself or interior compartments of the vehicle 100. In one or more arrangements, the vehicle sensor(s) 121 can be configured to detect and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system, and/or other suitable sensors. The vehicle sensor(s) 121 can be configured to detect and/or sense one or more characteristics of the vehicle 100. In one or more arrangements, the vehicle sensor(s) 121 can include a speedometer to determine a current speed of the vehicle 100. Moreover, the vehicle sensor system 121 can include sensors throughout a passenger compartment, such as pressure/weight sensors in seats, seatbelt sensors, camera(s), and so on.

Alternatively, or in addition, the sensor system 120 can include one or more environment sensors 122 configured to acquire and/or sense driving environment data. “Driving environment data” includes data or information about the external environment in which an autonomous vehicle is located or one or more portions thereof. For example, the one or more environment sensors 122 can be configured to detect and/or sense obstacles in at least a portion of the external environment of the vehicle 100 and/or information/data about such obstacles. Such obstacles may be stationary objects and/or dynamic objects. The one or more environment sensors 122 can be configured to detect, and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 can include one or more radar sensors, one or more LIDAR sensors, one or more sonar sensors, and/or one or more cameras. In one or more arrangements, the one or more cameras can be high dynamic range (HDR) cameras or infrared (IR) cameras.

The vehicle 100 can include an input system 130. An “input system” includes, without limitation, devices, components, systems, elements or arrangements or groups thereof that enable information/data to be entered into a machine. The input system 130 can receive an input from a vehicle passenger (e.g., an operator or a passenger). The vehicle 100 can include an output system 140. An “output system” includes any device, component, or arrangement or groups thereof that enable information/data to be presented to a vehicle passenger (e.g., a person, a vehicle passenger, etc.).

The vehicle 100 can include one or more vehicle systems 150. Various examples of the one or more vehicle systems 150 are shown in FIG. 1, however, the vehicle 100 can include a different combination of systems than illustrated in the provided example. In one example, the vehicle 100 can include a propulsion system, a braking system, a steering system, throttle system, a transmission system, a signaling system, a navigation system, and so on. The noted systems can separately or in combination include one or more devices, components, and/or a combination thereof.

By way of example, the navigation system can include one or more devices, applications, and/or combinations thereof configured to determine the geographic location of the vehicle 100 and/or to determine a travel route for the vehicle 100. The navigation system can include one or more mapping applications to determine a travel route for the vehicle 100. The navigation system can include a global positioning system, a local positioning system or a geolocation system.

The processor(s) 110, the depth system 170, and/or the assistance system 160 can be operatively connected to communicate with the various vehicle systems 150 and/or individual components thereof. For example, returning to FIG. 1, the processor(s) 110 and/or the assistance system 160 can be in communication to send and/or receive information from the various vehicle systems 150 to control the movement, speed, maneuvering, heading, direction, etc. of the vehicle 100. The processor(s) 110, the depth system 170, and/or the assistance system 160 may control some or all of these vehicle systems 150 and, thus, may be partially or fully autonomous.

The processor(s) 110, the depth system 170, and/or the assistance system 160 can be operatively connected to communicate with the various vehicle systems 150 and/or individual components thereof. For example, returning to FIG. 1, the processor(s) 110, the depth system 170, and/or the assistance system 160 can be in communication to send and/or receive information from the various vehicle systems 150 to control the movement, speed, maneuvering, heading, direction, etc. of the vehicle 100. The processor(s) 110, the depth system 170, and/or the assistance system 160 may control some or all of these vehicle systems 150.

The processor(s) 110, the depth system 170, and/or the assistance system 160 may be operable to control the navigation and/or maneuvering of the vehicle 100 by controlling one or more of the vehicle systems 150 and/or components thereof. For instance, when operating in an autonomous mode, the processor(s) 110, the depth system 170, and/or the assistance system 160 can control the direction and/or speed of the vehicle 100. The processor(s) 110, the depth system 170, and/or the assistance system 160 can cause the vehicle 100 to accelerate (e.g., by increasing the supply of energy provided to the engine), decelerate (e.g., by decreasing the supply of energy to the engine and/or by applying brakes) and/or change direction (e.g., by turning the front two wheels).

Moreover, the depth system 170 and/or the assistance system 160 can function to perform various driving-related tasks. The vehicle 100 can include one or more actuators. The actuators can be any element or combination of elements operable to modify, adjust and/or alter one or more of the vehicle systems or components thereof to responsive to receiving signals or other inputs from the processor(s) 110 and/or the assistance system 160. Any suitable actuator can be used. For instance, the one or more actuators can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more modules that form the assistance system 160. The assistance system 160 can be configured to receive data from the sensor system 120 and/or any other type of system capable of capturing information relating to the vehicle 100 and/or the external environment of the vehicle 100. In one or more arrangements, the assistance system 160 can use such data to generate one or more driving scene models. The assistance system 160 can determine the position and velocity of the vehicle 100. The assistance system 160 can determine the location of obstacles, or other environmental features, including traffic signs, trees, shrubs, neighboring vehicles, pedestrians, and so on.

The assistance system 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The assistance system 160 either independently or in combination with the depth system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 240. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The assistance system 160 can be configured to implement determined driving maneuvers. The assistance system 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The assistance system 160 can be configured to execute various vehicle functions and/or to transmit data to, receive data from, interact with, and/or control the vehicle 100 or one or more systems thereof (e.g., one or more of vehicle systems 150).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, another magnetic medium, an ASIC, a CD, another optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment,” “an embodiment.” “one example.” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having.” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A depth system, comprising:
one or more processors;
a memory communicably coupled to the one or more processors and storing instructions that, when executed by the one or more processors, cause the one or more processors to:
acquire sensor data including at least an image of a surrounding environment;
encode the sensor data into features using an encoder of a depth model;
decode the features into a depth map using a decoder of the depth model according to an affinity-based shift correction embedded with the decoder; and
provide the depth map that indicates depths within the surrounding environment.

2. The depth system of claim 1, wherein the sensor data includes the image and sparse depth data corresponding to the image, wherein the instructions to acquire the sensor data include instructions to derive the image from one of a camera and a LiDAR, and
wherein the instructions to decode the features include instructions to integrate the sparse depth data into the decoder through the affinity-based shift correction.

3. The depth system of claim 1, wherein the instructions to decode the features using the affinity-based shift correction include instructions to iteratively align depth predictions to sparse depth data from the sensor data according to predicted affinities between the sparse depth data and pixels of the features.

4. The depth system of claim 1, wherein the instructions to decode the features using the affinity-based shift correction include instructions to determine an affinity for depth points from the sensor data in relation to an intermediate depth map by computing the affinity between pairs of the depth points and pixels of the intermediate depth map.

5. The depth system of claim 4, wherein the instructions to decode the features using the affinity-based shift correction include instructions to generate the depth map using the affinities to correlate the depth points and determine depth errors to correct the depth map.

6. The depth system of claim 1, wherein the instructions to decode the features using the affinity-based shift correction include instructions to apply a correction confidence prediction to selectively integrate information from sparse depth data into decoding the depth map from the features.

7. The depth system of claim 1, wherein the instructions to provide the depth map include instructions to communicate the depth map to one or more systems within a vehicle to facilitate control of the vehicle, and
wherein the depth model performs monocular depth estimation.

8. The depth system of claim 1, wherein the depth system is integrated within a vehicle, and wherein the depth model selectively accepts depth data in addition to the image.

9. A non-transitory computer-readable medium storing instructions that, when executed by one or more processors, cause the one or more processors to:
acquire sensor data including at least an image of a surrounding environment;
encode the sensor data into features using an encoder of a depth model;
decode the features into a depth map using a decoder of the depth model according to an affinity-based shift correction embedded with the decoder; and
provide the depth map that indicates depths within the surrounding environment.

10. The non-transitory computer-readable medium of claim 9,
wherein the sensor data includes the image and sparse depth data corresponding to the image, and
wherein the instructions to decode the features include instructions to integrate the sparse depth data into the decoder through the affinity-based shift correction.

11. The non-transitory computer-readable medium of claim 9, wherein the instructions to decode the features using the affinity-based shift correction include instructions to iteratively align depth predictions to sparse depth data from the sensor data according to predicted affinities between the sparse depth data and pixels of the features.

12. The non-transitory computer-readable medium of claim 9, wherein the instructions to decode the features using the affinity-based shift correction include instructions to determine an affinity for depth points from the sensor data in relation to an intermediate depth map by computing the affinity between pairs of the depth points and pixels of the intermediate depth map.

13. The non-transitory computer-readable medium of claim 12, wherein the instructions to decode the features using the affinity-based shift correction include instructions to generate the depth map using the affinities to correlate the depth points and determine depth errors to correct the depth map.

14. A method, comprising:
acquiring sensor data including at least an image of a surrounding environment;
encoding the sensor data into features using an encoder of a depth model;
decoding the features into a depth map using a decoder of the depth model according to an affinity-based shift correction embedded with the decoder; and
providing the depth map that indicates depths within the surrounding environment.

15. The method of claim 14, wherein the sensor data includes the image and sparse depth data corresponding to the image, wherein acquiring the sensor data includes deriving the image from one of a camera and a LiDAR, and
wherein decoding the features includes integrating the sparse depth data into the decoder through the affinity-based shift correction.

16. The method of claim 14, wherein decoding the features using the affinity-based shift correction includes iteratively aligning depth predictions to sparse depth data from the sensor data according to predicted affinities between the sparse depth data and pixels of the features.

17. The method of claim 14, wherein decoding the features using the affinity-based shift correction includes determining an affinity for depth points from the sensor data in relation to an intermediate depth map by computing the affinity between pairs of the depth points and pixels of the intermediate depth map.

18. The method of claim 17, wherein decoding the features using the affinity-based shift correction includes generating the depth map using the affinities to correlate the depth points and determine depth errors to correct the depth map.

19. The method of claim 14, wherein decoding the features using the affinity-based shift correction includes applying a correction confidence prediction to selectively integrate information from sparse depth data into decoding the depth map from the features.

20. The method of claim 14, wherein providing the depth map includes communicating the depth map to one or more systems within a vehicle to facilitate control of the vehicle, and
wherein the depth model performs monocular depth estimation.
